(19) United States
(12) Patent Application Publication
(10) Pub. No.: US 2018/0191116 A1
(43) Pub. Date: Jul. 5, 2018

(54) ELECTRONIC DEVICE

(71) Applicant: Acer Incorporated, New Taipei City (TW)

(72) Inventors: Yu-Shih Wang, New Taipei City (TW); Chih-Chun Liu, New Taipei City (TW); Po-Yi Lee, New Taipei City (TW)

(73) Assignee: Acer Incorporated, New Taipei City (TW)

(21) Appl. No.: 15/657,219

(22) Filed: Jul. 24, 2017

(30) Foreign Application Priority Data
Jan. 5, 2017 (TW) 106100272

(51) Int. Cl. H01R 33/74; H01R 13/6585

(52) U.S. Cl. CPC H01R 33/74; H01R 13/6585

(57) ABSTRACT

An electronic device includes a display and a docking station. The display includes a first connector, and the docking station has a second connector. The first connector includes a first tongue portion and pins at least including a pair of transmitting differential signal pins and ground pins. An orthogonal projection of at least one ground pin on an upper surface of the first tongue portion is located between the transmitting differential signal pins. The transmitting differential signal pins are used to transmit data adopting USB3.1, thunderbolt 2, or thunderbolt 3 transmission specification. The second connector includes a second tongue portion and through holes at least including a pair of transmitting differential signal through holes and ground through holes. The transmitting differential signal pins and the ground pins are connected to the transmitting differential signal through holes and the ground through holes respectively.

### CROSS-REFERENCE TO RELATED APPLICATION

This application claims the priority benefit of Taiwan application serial no. 106100272, filed on Jan. 5, 2017. The entirety of the above-mentioned patent application is hereby incorporated by reference herein and made a part of this specification.

### BACKGROUND OF THE INVENTION

### Field of the Invention

The invention relates to an electronic device, particularly an electronic device including a connector capable of high-speed signal transmission.

### Description of Related Art

Electrical connector is a common electronic component of electronic devices, capable of being connected to matching electrical connectors of other electronic devices and further enabling signal and electricity transmission between two electronic devices. One of the existing electrical connectors, for example, a universal serial bus (USB) 3.1 electrical connector with newly added electrical connector Type C specification, is capable of not only transmitting data at an ultra speed, 10 Gbps, but also in the volume of light and thin and being suitable for mobile phones and other portable equipment, and can be connected upright or upside down due to the symmetrical socks. Such USB 3.1 electrical connector is thus commonly applied on a variety of electronic devices.

There are 12 terminals respectively on the upper and lower rows of the USB Type C electrical connector mentioned above and they are arranged parallel to one another equidistantly. Orthogonal projections of the upper row terminals and the lower row terminals on the same horizontal plane are overlapped. However, signal terminals of the USB Type C electrical connector are responsible for transmitting signals of high frequency. When high frequency signal passing through the signal terminals, the signals of high frequency are easily interfered by signals or electrical current from the other adjacent conducting terminals. The signals of high frequency thus cannot pass through the signal terminals stably. As a result, problems such as over-high impedance, input loss, and return loss of the signals terminals are easily triggered, leading to instability or a decrease in efficiency when terminal groups are transmitting signals and further decreasing the integrity of the signals.

### SUMMARY OF THE INVENTION

The invention provides an electronic device, of which a connector can perform high-speed signal transmitting operations and can obtain excellent signal integrity.

The electronic device of the invention includes a display and a docking station. The display includes a first connector. The first connector includes a first tongue portion and a plurality of pins. The pins at least include a pair of transmitting differential signal pins and at least one ground pin. The first tongue portion has an upper surface and a lower surface opposite to each other. The transmitting differential signal pins are configured on the upper surface of the first tongue portion while at least one of the ground pins is configured on the lower surface of the first tongue portion. An orthogonal projection of at least one of the ground pins on the upper surface of the first tongue portion is located between the transmitting differential signal pins. The transmitting differential signal pins transmit data adopting universal serial bus (USB) 3.1, thunderbolt 2, or thunderbolt 3 transmission specification. The docking station is detachably connected to the display and includes a second connector. The second connector includes a second tongue portion and a plurality of through holes. The through holes at least include a pair of transmitting differential signal through holes and a plurality of ground through holes. The second tongue portion has a first side and a second side opposite to each other. The transmitting differential signal through holes are configured in the second side of the second tongue portion while at least one of the ground through holes is configured in the first side of the second tongue portion. An orthogonal projection of at least one of the ground through holes in the second side of the second tongue portion is located between the transmitting differential signal through holes. When the display is assembled onto the docking station, the transmitting differential signal pins and the ground pins of the first connector are respectively connected to the transmitting differential signal through holes and the ground through holes of the second connector so that the display is electrically connected to the docking station.

In an embodiment of the invention, the pins further include a pair of receiving differential signal pins and a pair of transmitting/receiving differential signal pins. The receiving differential signal pins are configured on the lower surface of the first tongue portion while the transmitting/receiving differential signal pins are configured on the upper surface of the first tongue portion. Orthogonal projections of the receiving differential signal pins on the upper surface of the first tongue portion and the transmitting/receiving differential signal pins are alternately arranged.

In an embodiment of the invention, the through holes further include a pair of receiving differential signal through holes and a pair of transmitting/receiving differential signal through holes. The receiving differential signal through holes are configured in the first side of the second tongue portion while the transmitting/receiving differential signal through holes are configured in the second side of the second tongue portion. Orthogonal projections of the receiving differential signal through holes in the second side of the second tongue portion and the transmitting/receiving differential signal through holes are alternately arranged. When the display is assembled onto the docking station, the receiving differential signal pins and the transmitting/receiving differential signal pins of the first connector are respectively connected to the receiving differential signal through holes and the transmitting/receiving differential signal through holes of the second connector.

In an embodiment of the invention, the receiving differential signal pins conform to USB 3.1, thunderbolt 2, or thunderbolt 3 transmission specification.

In an embodiment of the invention, the transmitting/receiving differential signal pins conform to USB2.0 transmission specification.

In an embodiment of the invention, the pins further include a plurality of detecting pins respectively configured on the upper surface and the lower surface of the first tongue portion. The through holes further include a plurality of detecting through holes respectively configured in the first side and the second side of the second tongue portion. When the display is assembled onto the docking station, the detecting pins of the first connector are connected to the detecting through holes of the second connector respectively.

In an embodiment of the invention, the pins further include a plurality of power-supply pins respectively configured on the upper surface and the lower surface of the first tongue portion. The through holes further include a plurality of power-supply through holes respectively configured in the first side and the second side of the second tongue portion. When the display is assembled onto the docking station, the power-supply pins of the first connector are connected to the power-supply through holes of the second connector respectively. A ratio of a cross-sectional area of each of the power-supply pins to a cross-sectional area of each of the ground pins is ½.

In an embodiment of the invention, a ratio of a width of each of the through holes to a width of each of the pins is 0.4.

In an embodiment of the invention, the first connector and the second connector are respectively a connector compatible with USB Type-C.

In an embodiment of the invention, the display further includes a display unit and a U-frame. The docking station further includes a docking unit and a hinge structure. The display unit is assembled onto the U-frame while the first connector is assembled into the U-frame, the docking device is assembled onto the hinge structure, the second connector is assembled into the hinge structure, and the U-frame is assembled onto the hinge structure so as to detachably assemble the display onto the docking station.

Based on the above, in the design of the electronic device of the invention, the first connector has the transmitting differential signal pins used to transmit data adopting USB 3.1, thunderbolt 2, or thunderbolt 3 transmission specification, wherein the orthogonal projection of at least one the ground pins on the upper surface of the first tongue portion is located between the transmitting differential signal pins, and the second connector has the transmitting differential signal through holes and the ground through holes disposed in accordance with the transmitting differential signal pins and ground pins of the first connector. Thereby, when the display is assembled onto the docking station, the transmitting differential signal pins and the ground pins of the first connector are respectively connected to the transmitting differential signal through holes and the ground through holes of the second connector, so that the display is electrically connected to the docking station. As a result, the electronic device of the invention can not only perform high-speed signal transmission operations to transmit high-speed signals but also improve the integrity of signals to obtain excellent signal integrity.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a diagram showing an electronic device in an embodiment of the invention.

FIG. 2 is a schematic enlarged view of a portion of a display and a docking station in FIG. 1.

FIG. 3 is a diagram showing a first connector of the display and a second connector of the docking station in FIG. 2.

FIG. 4 is a schematic cross-sectional view of the first connector and the second connector in FIG. 3.

FIG. 5A is a schematic top view of the first connector in FIG. 4.

FIG. 5B is a schematic bottom view of the first connector in FIG. 4.

FIG. 6A is a schematic perspective view of a portion of the first connector in FIG. 4.

FIG. 6B is a schematic top view of pins of the first connector connected to through holes of the second connector in FIG. 3.

### DESCRIPTION OF THE EMBODIMENTS

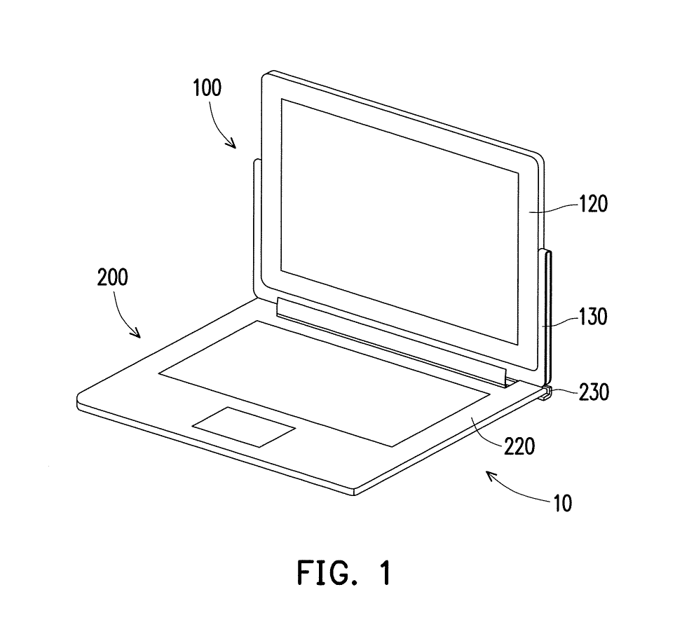

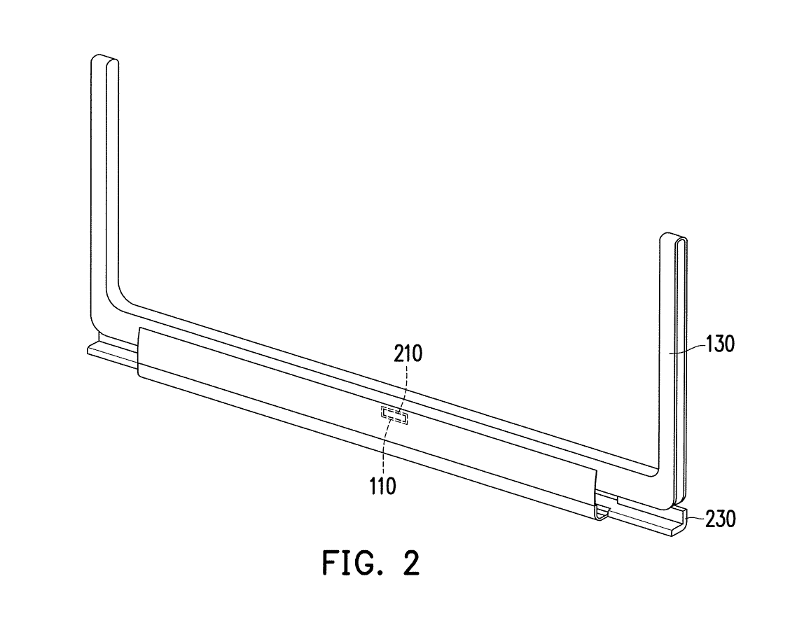

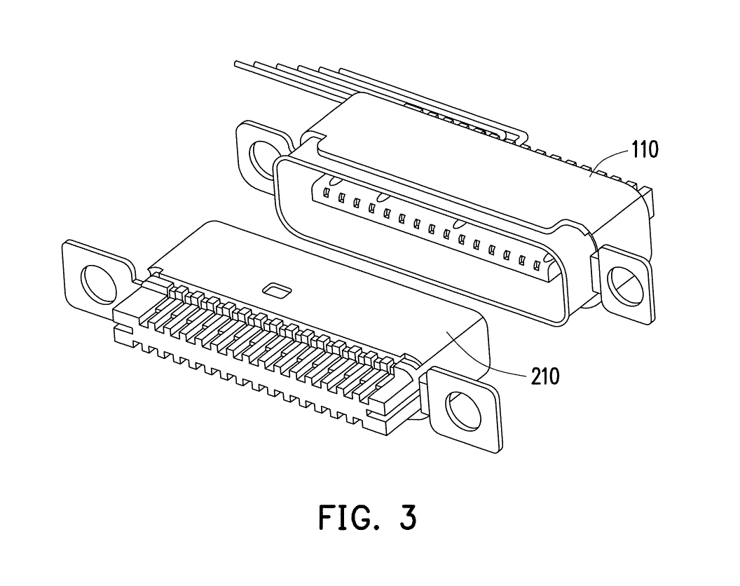

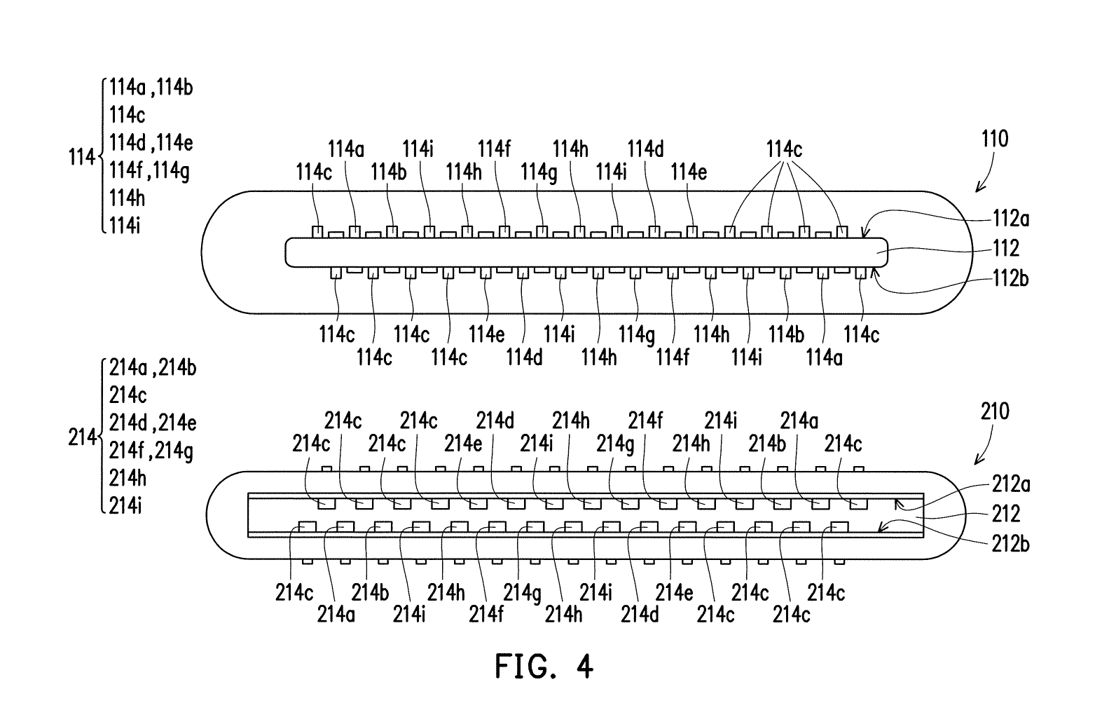

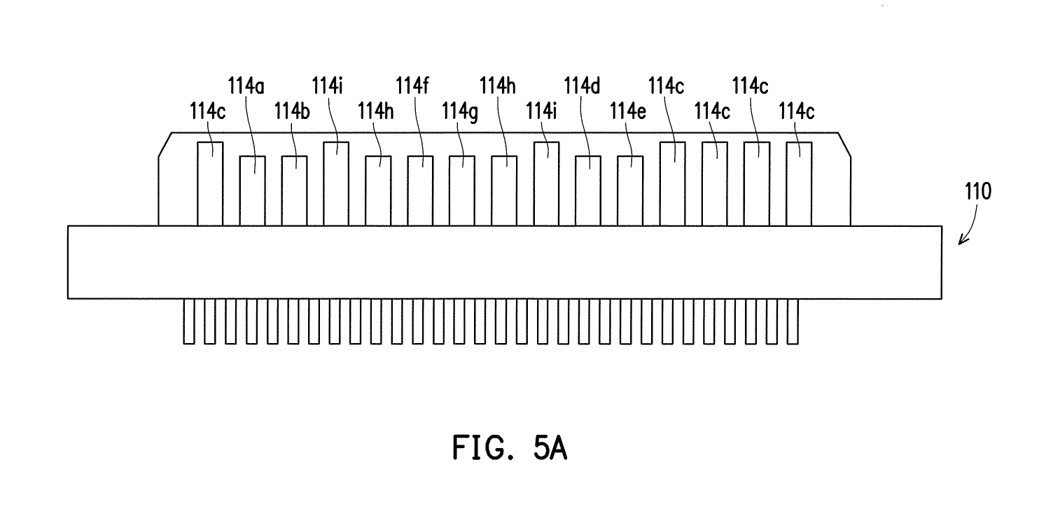

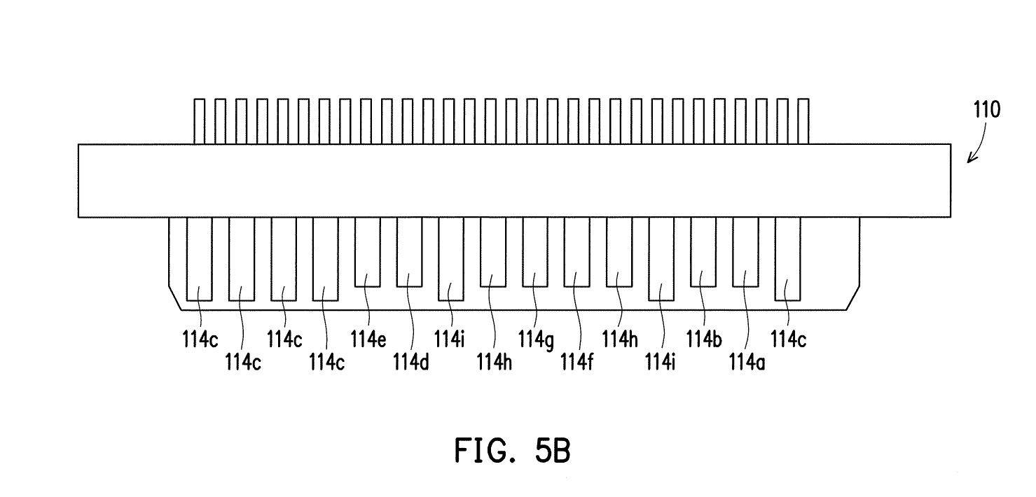

FIG. 1 is a diagram of an electronic device in an embodiment of the invention. FIG. 2 is a schematic enlarged view of a portion of a display and a docking station in FIG. 1. FIG. 3 is a diagram showing a first connector of the display and a second connector of the docking station in FIG. 2. FIG. 4 is a schematic cross-sectional view of the first connector and the second connector in FIG. 3. FIG. 5A is a schematic top view of the first connector in FIG. 4. FIG. 5B is a schematic bottom view of the first connector in FIG. 4.

Please refer to FIGS. 1, 2, 3, 4, 5A, and 5B altogether. An electronic device 10 in the embodiment of the invention includes a display 100 and a docking station 200. The display 100 includes a first connector 110. The first connector 110 includes a first tongue portion 112 and a plurality of pins 114. The pins 114 at least include a pair of transmitting differential signal pins 114a and 114b and a plurality of ground pins 114c. The first tongue portion 112 has an upper surface 112a and a lower surface 112b opposite to each other. The transmitting differential signal pins 114a and 114b are configured on the upper surface 112a of the first tongue portion 112. At least one of the ground pins 114c is configured on the lower surface 112b of the first tongue portion 112. An orthogonal projection of at least one of the ground pins 114c on the upper surface 112a of the first tongue portion 112 is located between the transmitting differential signal pins 114a and 114b. The transmitting differential signal pins 114a and 114b are used to transmit data adopting USB 3.1, thunderbolt 2, or thunderbolt 3 transmission specification.

Please refer to FIGS. 1, 2, 3, 4, 5A, and 5B altogether. The docking station 200 in the embodiment of the invention is detachably connected to the display 100. The docking station 200 includes a second connector 210. The second connector 210 includes a second tongue portion 212 and a plurality of through holes 214. The through holes 214 at least include a pair of transmitting differential signal through holes 214a and 214b and a plurality of ground through holes 214c. The second tongue portion 212 has a first side 212a and a second side 212b opposite to each other. The transmitting differential signal through holes 214a and 214b are configured in the second side 212b of the second tongue portion 212. At least one of the ground through holes 214c is configured in the first side 212a of the second tongue portion 212. An orthogonal projection of at least one of the ground through holes 214c in the second side 212b of the second tongue portion 212 is located between the transmitting differential signal through holes 214a and 214b. When the display 100 is assembled onto the docking station 200, the transmitting differential signal pins 114a and 114b and the ground pins 114c of the first connector 110 are respectively connected to the transmitting differential signal through holes 214a and 214b and the ground through holes 214c of the second connector 210, so that the display 100 is electrically connected to the docking station 200.

Please refer to FIGS. 1 and 2. To be more specific, the display 100 in the embodiment of the invention further includes a display unit 120 and a U-frame 130. The display unit 120 is assembled onto the U-frame 130 while the first connector 110 is assembled into the U-frame 130. The display unit 120 here may be, for example, a tablet computer or a display screen including a host. The U-frame 130 may be unfolded relative to the display unit 120, so as to support the display unit 120 when the display 100 is used alone. Thereby, the user may adjust an angle between the display unit 120 and the U-frame 130 for a better watching angle.

On the other hand, the docking station 200 in the embodiment of the invention further includes a docking unit 220 and a hinge structure 230. The docking unit 220 is assembled onto the hinge structure 230 while the second connector 210 is assembled into the hinge structure 230. The docking unit 220 here may be, for example, a keyboard module. The hinge structure 230 here may be, for example, assembled to the U-frame 130 of the display 100 through a magnetic force. Nevertheless, the invention is not limited to the above. Since the U-frame 130 of the display 100 in the embodiment of the invention is assembled onto the hinge structure 230 through the magnetic force, the display 100 is detachably assembled onto the docking station 200. That is to say, the display 100 of the electronic device 10 in the embodiment of the invention may be used alone or with the docking station 200.

Please refer to FIGS. 4, 5A, and 5B. Furthermore, the pins 114 of the first connector 110 in the embodiment of the invention further include a pair of receiving differential signal pins 114d and 114e and a pair of transmitting/receiving differential signal pins 114f and 114g. The receiving differential signal pins 114d and 114e are configured on the lower surface 112b of the first tongue portion 112. The transmitting/receiving differential signal pins 114f and 114g are configured on the upper surface 112a of the first tongue portion 112. Orthogonal projections of the receiving differential signal pins 114d and 114e on the upper surface 112a of the first tongue portion 112 and the transmitting/receiving differential signal pins 114f and 114g are alternately arranged. The receiving differential signal pins 114d and 114e here conform to USB 3.1, thunderbolt 2, or thunderbolt 3 transmission specification. The transmitting/receiving differential signal pins 114f and 114g conform to USB 2.0 transmission specification.

Please refer to FIG. 4. Accordingly, the through holes 214 of the second connector 210 further include a pair of receiving differential signal through holes 214d and 214e and a pair of transmitting/receiving differential signal through holes 214f and 214g. The receiving differential signal through holes 214d and 214e are configured in the first side 212a of the second tongue portion 212. The transmitting/receiving differential signal through holes 214f and 214g are configured in the second side 212b of the second tongue portion 212. Orthogonal projections of the receiving differential signal through holes 214d and 214e in the second side 212b of the second tongue portion 212 and the transmitting/receiving differential signal through holes 214f and 214g are alternately arranged. Thus, when the display 100 is assembled onto the docking station 200, the receiving differential signal pins 114d and 114e and the transmitting/receiving differential signal pins 114f and 114g of the first connector 110 are respectively connected to the receiving differential signal through holes 214d and 214e and the transmitting/receiving differential signal through holes 214f and 214g of the second connector 210.

Please refer to FIGS. 4, 5A, and 5B. Furthermore, the pins 114 of the first connector 110 in the embodiment of the invention further include a plurality of detecting pins 114h and a plurality of power-supply pins 114i. The detecting pins 114h are respectively configured on the upper surface 112a and the lower surface 112b of the first tongue portion 112. The detecting pins 114h are capable of detecting whether or not the first connector 110 is connected to the second connector 210 and whether the first connector 110 is connected upright or upside down to the second connector 210 when they are connected. The power-supply pins 114i are respectively configured on the upper surface 112a and the lower surface 112b of the first tongue portion 112. The power-supply pins 114i has a function of supplying electricity. Please further refer to FIG. 4. Accordingly, the through holes 214 of the second connector 210 further include a plurality of detecting through holes 214h and a plurality of power-supply through holes 214i. The detecting through holes 214h are respectively configured in the first side 212a and the second side 212b of the second tongue portion 212. The power-supply through holes 214i are also respectively configured in the first side 212a and the second side 212b of the second tongue portion 212. When the display 100 is assembled onto the docking station 200, the detecting pins 114h and the power-supply pins 114i of the first connector 110 are respectively connected to the detecting through holes 214h and the power-supply through holes 214i of the second connector 210.

Please refer to FIGS. 4, 5A, and 5B. To be more specific, the first connector 110 in the embodiment of the invention is embodied as a connector compatible with USB Type-C when the transmitting differential signal pins 114a and 114b and the receiving differential signal pins 114d and 114e transmit data adopting USB 3.1 or thunderbolt 3 transmission specification. That is to say, the first connector 110 may be connected upright or upside down. Comparing with the conventional USB Type-C connector that has 24 pins, the first connector 110 has 6 more ground pins 114c. In other words, the first connector 110 in the embodiment of the invention has 30 pins 114 in total, including two pairs of the transmitting differential signal pins 114a and 114b, two pairs of the receiving differential signal pins 114d and 114e, and two pairs of the transmitting/receiving differential signal pins 114f and 114g as described above. The pins 114 are respectively configured on the upper surface 112a and the lower surface 112b of the first tongue portion 112. As shown in FIG. 5, the pins 114 configured in an upper row (i.e. the upper surface 112a of the first tongue portion 112) in order are, from left to right, the ground pin 114c, the transmitting differential signal pin 114a (used to transmit a high-speed differential signal Tx+), the transmitting differential signal pin 114b (used to transmit a high-speed differential signal Tx−), the power-supply pin 114i, the detecting pin 114h, the transmitting/receiving differential signal pin 114f (used to transmit a USB 2.0 differential signal D+), the transmitting/receiving differential signal pin 114g (used to transmit a USB 2.0 differential signal D−), the detecting pin 114h, the power-supply pin 114i, the receiving differential signal pin 114d (used to transmit a high-speed differential signal Rx+), the receiving differential signal pin 114e (used to transmit a high-speed differential signal Rx−), the ground pin 114c, the ground pin 114c, the ground pin 114c, and the ground pin 114c. On the other hand, as shown in FIG. 5B, the pins 114 configured in a lower row (i.e. the lower surface 112b of the first tongue portion 112) in order are, from left to right, the ground pin 114c, the ground pin 114c, the ground pin 114c, the ground pin 114c, the receiving differential signal pin 114e, the receiving differential signal pin 114d, the power-supply pin 114i, the detecting pin 114h, the transmitting/receiving differential signal pin 114g, the transmitting/receiving differential signal pin 114f, the detecting pin 114h, the power-supply pin 114i, the transmitting differential signal pin 114b, the transmitting differential signal pin 114a, and the ground pin 114c.

In short, the pins 114 in the upper row and the pins 114 in the lower row of the first connector 110 are arranged in the opposite orders. Thereby, the first connector 110 may be connected upright or upside down. Moreover, orthogonal projections of the pins 114 in the upper row of the first connector 110 on the lower surface 112b of the first tongue portion 112 and the pins 114 in the lower row are alternately arranged. That is to say, the pins 114 in the upper row and the pins 114 in the lower row are not arranged symmetrically one to one, but alternately arranged. When high frequency signals pass through the transmitting differential signal pins 114a and 114b, the signals are less likely to be interfered by the electrical current or signals from other adjacent conducting terminals due to the design that the orthogonal projections of the ground pins 114c on the upper surface 112a of the first tongue portion 112 are located between the transmitting differential signal pins 114a and 114b. Thereby, the integrity of the signals is improved and favorable integrity of the signals is achieved.

Please refer to FIG. 4. Accordingly, the second connector 210 in the embodiment of the invention may be connected to the first connector 110. The second connector 210 here is embodied as a connector compatible with USB Type-C. The through holes 214 of the second connector 210 are disposed in accordance with the pins 114 of the first connector 110. As a result, the through holes 214 in the upper row (i.e. the first side 212a of the second tongue portion 212) in order are, from left to right, the ground through hole 214c, the ground through hole 214c, the ground through hole 214c, the ground through hole 214c, the receiving differential signal through hole 214e, the receiving differential signal through hole 214d, the power-supply through hole 214i, the detecting through hole 214h, the transmitting/receiving differential signal through hole 214g, the transmitting/receiving differential signal through hole 214f, the detecting through hole 214h, the power-supply through hole 214i, the transmitting differential signal through hole 214b, the transmitting differential signal through hole 214a, and the ground through hole 214c. On the other hand, the through holes 214 in the lower row (i.e. the second side 212b of the second tongue portion 212) in order are, from left to right, the ground through hole 214c, the transmitting differential signal through hole 214a, the transmitting differential signal through hole 214b, the power-supply through hole 214i, the detecting through hole 214h, the transmitting/receiving differential signal through hole 214f, the transmitting/receiving differential signal through hole 214g, the detecting through hole 214h, the power-supply through hole 214i, the receiving differential signal through hole 214d, the receiving differential signal through hole 214e, the ground through hole 214c, the ground through hole 214c, the ground through hole 214c, and the ground through hole 214c.

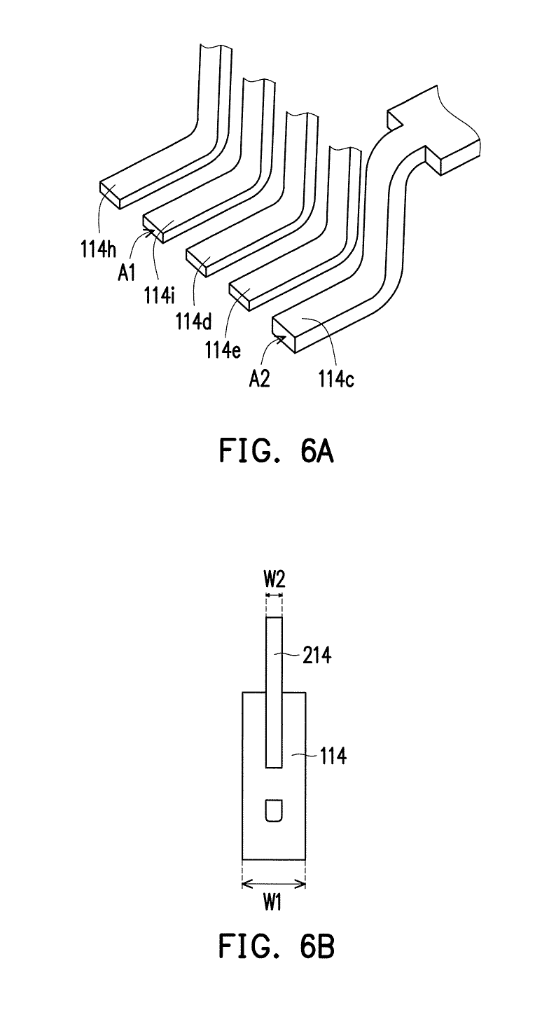

Please refer to FIG. 6A. To effectively improve the quality of signal transmission, a ratio of a cross-sectional area of each of the power-supply pins 114i to a cross-sectional area of each of the ground pins 114c in the embodiment is ½. That is to say, a cross-sectional area A2 of each of the ground pins 114c is twice a cross-sectional area A1 of the power-supply pin 114i. Moreover, a ratio of a width of each of the through holes 214 of the second connector 210 to a width of each of the pins 114 of the first connector 110 is preferably 0.4. In other words, a width W2 of each of the through holes 214 of the second connector 210 is smaller than a width W1 of each of the pins 114 of the first connector 110.

To conclude the above, in the design of the electronic device of the invention, the first connector has the transmitting differential signal pins used to transmit data adopting USB 3.1, thunderbolt 2, or thunderbolt 3 transmission specification, wherein the orthogonal projection of at least one the ground pin on the upper surface of the first tongue portion is located between the transmitting differential signal pins, and the second connector has the transmitting differential signal through holes and the ground through hole disposed in accordance with the transmitting differential signal pins and the ground pin of the first connector. Thus, when the display is assembled onto the docking station, the transmitting differential signal pins and the ground pins of the first connector may be respectively connected to the transmitting differential signal through holes and the ground through holes of the second connector, so that the display is electrically connected to the docking station. As a result, the electronic device of the invention can not only perform high-speed signal transmission operations to transmit high-speed signals but also improve the integrity of the signals to obtain excellent signal integrity.

It will be apparent to those skilled in the art that various modifications and variations can be made to the disclosed embodiments without departing from the scope or spirit of this invention. In view of the foregoing, it is intended that the invention covers modifications and variations provided that they fall within the scope of the following claims and their equivalents.

What is claimed is:

1. An electronic device, comprising:
a display comprising a first connector, and the first connector comprising a first tongue portion and a plurality of pins, the pins at least comprising a pair of transmitting differential signal pins and a plurality of ground pins, the first tongue portion having an upper surface and a lower surface opposite to each other, the pair of transmitting differential signal pins configured on the upper surface of the first tongue portion, and at least one of the ground pins configured on the lower surface of the first tongue portion, wherein an orthogonal projection of at least one of the ground pins on the upper surface of the first tongue portion is located between the pair of transmitting differential signal pins, and the pair of transmitting differential signal pins transmit data adopting USB3.1, thunderbolt 2, or thunderbolt 3 transmission specification; and
a docking station detachably connected to the display and comprising a second connector, and the second connector comprising a second tongue portion and a plurality of through holes, the through holes at least comprising a pair of transmitting differential signal through holes and a plurality of ground through holes, the second tongue portion having a first side and a second side opposite to each other, the pair of transmitting differential signal through holes configured in the second side of the second tongue portion, and at least one of the ground through holes configured in the first side of the second tongue portion, wherein an orthogonal projection of at least one of the ground through holes in the second side of the second tongue portion is located between the pair of transmitting differential signal through holes, and when the display is assembled onto the docking station, the pair of transmitting differential signal pins and the ground pins of the first connector are respectively connected to the pair of transmitting differential signal through holes and the ground through holes of the second connector so that the display is electrically connected to the docking station.

2. The electronic device according to claim 1, wherein the pins further comprise a pair of receiving differential signal pins and a pair of transmitting/receiving differential signal pins, the pair of receiving differential signal pins is configured on the lower surface of the first tongue portion, and the pair of transmitting/receiving differential signal pins is configured on the upper surface of the first tongue portion, and orthogonal projections of the pair of receiving differential signal pins on the upper surface of the first tongue portion and the pair of transmitting/receiving differential signal pins are alternately arranged.

3. The electronic device according to claim 2, wherein the through holes further comprise a pair of receiving differential signal through holes and a pair of transmitting/receiving differential signal through holes, the pair of receiving differential signal through holes is configured in the first side of the second tongue portion, and the pair of transmitting/receiving differential signal through holes is configured in the second side of the second tongue portion, and orthogonal projections of the pair of receiving differential signal through holes in the second side of the second tongue portion and the pair of transmitting/receiving differential signal through holes are alternately arranged, and when the display is assembled onto the docking station, the pair of receiving differential signal pins and the pair of transmitting/receiving differential signal pins of the first connector are respectively connected to the pair of receiving differential signal through holes and the pair of transmitting/receiving differential signal through holes of the second connector.

4. The electronic device according to claim 2, wherein the pair of receiving differential signal pins conform to USB3.1, thunderbolt 2, or thunderbolt 3 transmission specification.

5. The electronic device according to claim 2, wherein the pair of transmitting/receiving differential signal pins conform to USB2.0 transmission specification.

6. The electronic device according to claim 1, wherein the pins further comprise a plurality of detecting pins respectively configured on the upper surface and the lower surface of the first tongue portion, and the through holes further comprise a plurality of detecting through holes respectively configured in the first side and the second side of the second tongue portion, and when the display is assembled onto the docking station, the detecting pins of the first connector are connected to the detecting through holes of the second connector respectively.

7. The electronic device according to claim 1, wherein the pins further comprise a plurality of power-supply pins respectively configured on the upper surface and the lower surface of the first tongue portion, and the through holes further comprise a plurality of power-supply through holes respectively configured in the first side and the second side of the second tongue portion, and when the display is assembled onto the docking station, the power-supply pins of the first connector are connected to the power-supply through holes of the second connector respectively, and a ratio of a cross-sectional area of each of the power-supply pins to a cross-sectional area of each of the ground pins is ½.

8. The electronic device according to claim 1, wherein a ratio of a width of each of the through holes to a width of each of the pins is 0.4.

9. The electronic device according to claim 1, wherein the first connector and the second connector are respectively a connector compatible with USB Type-C.

10. The electronic device according to claim 1, wherein the display further comprises a display unit and a U-frame, and the docking station further comprises a docking unit and a hinge structure, the display unit is assembled onto the U-frame and the first connector is assembled into the U-frame, the docking unit is assembled onto the hinge structure and the second connector is assembled into the hinge structure, the U-frame is assembled onto the hinge structure so as to detachably assemble the display onto the docking station.
